(19) United States
(12) Patent Application Publication
(10) Pub. No.: US 2015/0140147 A1
(43) Pub. Date: May 21, 2015

(54) TWO-MOTOR MULTI-HEAD 3D PRINTER EXTRUSION SYSTEM

(71) Applicants: Joshua Frost Konstantinos, Camden, NJ (US); Michael Donald Smoluk, Philadelphia, PA (US)

(72) Inventors: Joshua Frost Konstantinos, Camden, NJ (US); Michael Donald Smoluk, Philadelphia, PA (US)

(21) Appl. No.: 14/543,677

(22) Filed: Nov. 17, 2014

Related U.S. Application Data
(60) Provisional application No. 61/904,868, filed on Nov. 15, 2013.

(51) Int. Cl. B29C 67/00

(52) U.S. Cl. CPC B29C 67/0051; B33Y 30/00; B29L 2031/767
USPC 425/131.1; 425/174

(57) ABSTRACT

A 3D printing system having a rotating plate wherein at least two printing components are selectively attached to said rotating plate, and wherein said rotating plate is capable or rotating to selectively engage each said printing component to a drive motor which is capable of driving the printing component when engaged.

This application claims priority to U.S. provisional application Ser. No. 61/904,868 filed Nov. 15, 2013, which is incorporated herein by reference in its entirety.

### FIELD OF INVENTION

The present application is generally related to 3D printers, more specifically, to fused filament fabrication (FFF) type 3D printers. FFF type 3D printers apply layers of thermoplastics, usually ABS or PLA to create three-dimensional materials. Some FFF 3D printers may even be designed to use other metal or plastics composites suitable for FFF type 3D printing. This process was initially invented by S. Scott Crimp in 1989 as described in U.S. Pat No. 5,121,329.

### BACKGROUND OF THE INVENTION

Typically, each printhead on a (FFF) 3D printer has its own dedicated motor, which will drive the plastic filament through the hot end of the device and out through the nozzle. The plastic filament thus is expelled out through the nozzle and applied to the printbed. Typically in a 3D printer, the positioning of the nozzle in the x, y, and z axis is controlled by g-code which is generated based off of a CAD model or a 3D scan. This allows for a 3D part to be created one layer at a time until you have a physical plastic 3D part.

One of the problems with the traditional approach to 3D printers is the limitation of materials that can be simultaneously printed. Generally, a reasonably priced 3D printer will only be able to print with a single material, because each different type of material requires its own printhead. Accordingly, to print with more than on material you need an increasing number of printheads. In 3D printers with more than one printhead, a second printhead, if available, is generally used for a removable support material. Such a second material allows printing of this removable material onto the print bed, to allow for creation of materials that would otherwise be unable to be printed directly from a single material. However, it is rare to see a FFF 3D printer with more than two print heads because of the difficulties and costs that arise and compound with each additional printhead.

The traditional FFF 3D printer typically aligns all of the printheads in a line on the x-axis. This orientation takes up valuable space on the x-axis thus reducing the ability of each of the heads to move along the full length of the x-axis in a gantry system, thus limiting the reach of each print head and ultimately the overall size of an object that can be created with a given 3D printer. Another difficulty, in such style of printhead system having two or more printheads, is that the printhead currently in use must be at least slightly lower on the Z-axis than the other head(s), instead of being aligned. If the other heads are kept at the same level, the nozzles on the other printheads will crash into the material that is being extruded by the operating printhead. Accordingly, these problems make it difficult and expensive to add more than two printheads to a typical 3D printing system.

Several patents have issued in an attempt to improve upon 3D printing systems. For example, U.S. Pat. No. 7,291,002 describes a system where rather than having a printhead(s) move about in an xyz gantry system, the printbed, or print drum as referred to in U.S. Pat. No. 7,291,002, rotates while an array of multiple printheads remains stationary. While interesting, this patent does not resolve the issues with each printhead requiring a dedicated motor, and while it has described a method to keep multiple printheads from crashing into material extruded by the other heads it does so, by fixing the printheads and revolving the bed, in a manner that necessitates an extremely large number of printheads. Moreover, this system would not work with existing software used to generate g-code from computer models or 3D scans.

U.S. Pat. No. 8,778,252 again rejects the typical Cartesian gantry in favor of a revolving system. In U.S. Pat. No. 8,778,252 it is imagined that benefits can be gained by moving the printheads around a circular printbed. They imagine that this design will allow for the use of multiple printheads without interference—although this would undoubtedly become more and more challenging as the number of printheads increased. Again, a major limitation of this design is that in its attempt to add multiple printheads, it rejects the Cartesian gantry system, which means that you have lost compatibility with a large amount of existing tools and software designed for a Cartesian based system.

U.S. Pat. No. 8,827,684 further modifies and describes a large printhead with separate stepper motors but a shared heater block and heating temperature sensor. As in U.S. Pat. No. 7,291,002 it solves the problem of multiple heads on the same level crashing into material extruded by the operating printhead, by rejecting the conventional xyz gantry design and instead using a revolving printbed. Again, this mean that the overall diameter of the print area is a factor of the number of printheads and that larger parts will require more printheads—each with its own dedicated stepper motor. Moreover, this approach loses the benefit of compatibility with existing software for xyz gantry systems.

CN 103660605 appears to be trying to patent an improvement to multi-layer 3D printing, based upon improvements to systems invented during the 1980's, by stacking print heads in some undefined orientation. However, this translated application does not clarify issues with regard to the use of multiple printheads as used in an XYZ gantry system.

However, none of these patents solves the issue of space on the X-axis within a printing system or allows a number of printing heads to be driven by a single motor. Instead, each of these systems relies upon a dedicated motor for each printing head.

There is a need for novel print head mechanisms, which allows for the use of multiple print heads controlled by a fewer number of motors, and more importantly does not have all of the print heads aligned on the same plane. The embodiments described herein allow for a greater number of materials to be used in the same print head without the increased cost and complexity of a typical system with a dedicated motor for each print head. Accordingly, Applicants have invented a 3D printer assembly that consists of a multi-head extrusion system, with multiple printheads which are not fixed at the same approximate height, but revolve into position and are driven with only two motors, a drive motor and a selection motor.

### SUMMARY OF THE INVENTION

There are many benefits to the embodiments described and depicted herein. The embodiments allow for multiple printheads to run in the same print—without concern over the other printheads, which are typically at the same level, crashing into or otherwise interfering with the material extruded by the operating printhead. Moreover, the embodiments eliminate the need for each printhead to have a dedicated motor, saving valuable space and reducing the overall cost and complexity of the machine. Additionally, the embodiments save valuable space on the x axis which means that with the embodiments described herein, a hypothetical ten material FFF 3D printer using the embodiments would be able to print a substantially larger object than an equivalent design with all the printheads on the same level.

In accordance with these and other objects, a first embodiment of the present invention comprises a two-motor multi-head filament extruder system that controls at least three 3D printer heads with only two motors. Wherein the multiple printer heads are on a revolving ring, which is rotated with one motor, and, once rotated to proper alignment with the gear chain, driven by the second motor.

A further embodiment is a 3D printing system suitable for use in a gantry system comprising a rotating disk, wherein attached to said rotating disc are a plurality of print extrusion heads, wherein said rotating disk is capable or selectively engaging and disengaging a print head by rotation of the disk, wherein by being engaged, a print extrusion head is engaged to a drive motor that is fixed on a non-rotating plate, print extrusion heads, being aligned along a circular plane, are rotated into, position on an axis for use in printing.

A further embodiment is directed to a 3D printing system comprising a rotating plate, at least one fixed plate, a rotating device, and a driving motor that is selectively attached to the fixed plate, wherein attached to the rotating plate are at least two printing components, wherein the printing components are selectively attached to the rotating ring, and wherein the rotating device rotates the rotating ring wherein the printing components are selectively engaged with the driving motor.

A further embodiment is directed to a 3D printing system comprising a rotating plate, at least one fixed plate, a rotating device, and a driving motor that is selectively attached to the fixed plate, wherein attached to the rotating plate are at least two printing components, wherein the printing components are selectively secured to the rotating ring, and wherein the rotating device rotates the rotating plate wherein the printing components are selectively engaged with the driving motor, and wherein the system further comprises a gear mechanism attached to the driving motor and a gear mechanism on the printing components for selectively engaging the components to the driving motor, wherein the 3D printing system further comprises a controlled separation mechanism to separate the driving motor gear mechanism from the gear mechanism on the printing components so as to disengage and then re-engage the gears as the printing components are rotated.

### BRIEF DESCRIPTION OF THE DRAWINGS

FIG. 1 depicts an embodiment of a two-motor multi-head 3D printer extrusion system as viewed from the front in trimetric perspective

FIG. 2 depicts an embodiment of a two-motor multi-head 3D printer extrusion system as viewed from the back on the system in trimetric perspective.

FIG. 3 depicts an exploded view of an assembly of a two-motor multi-head 3D printer extrusion system, as viewed from the back of the system in trimetric perspective.

FIG. 4 depicts an embodiment of a two-motor multi-head 3D printer extrusion system in a gantry system in an isometric view.

FIG. 5 depicts an embodiment comprising printing components such as a printing head, a spindle, and a laser.

### DETAILED DESCRIPTION OF THE PREFERRED EMBODIMENTS

The embodiments of the invention and the various features and advantages thereto are more fully explained with references to the non-limiting embodiments and examples that are described and set forth in the following descriptions of those examples. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims.

As used herein, terms such as “a,” “an,” and “the” include singular and plural referents unless the context clearly demands otherwise.

As used herein, the term “printing component” is a feature that can be used on the rotating ring to print material or otherwise modify the material that is already printed. Accordingly, printing components may be all printheads, or may include one or more print heads, and one or more spindles, or lasers as appropriate for the particular embodiment.

As use herein, the term “Bendix drive system gears” refers to a type of engagement mechanism traditionally used in starter motors of internal combustion engines. The device allows the pinion gear of the starter motor to engage or disengage with the flywheel as it has additional curvature on the sides of the gear teeth to ensure smooth alignment of the meshing gear teeth.

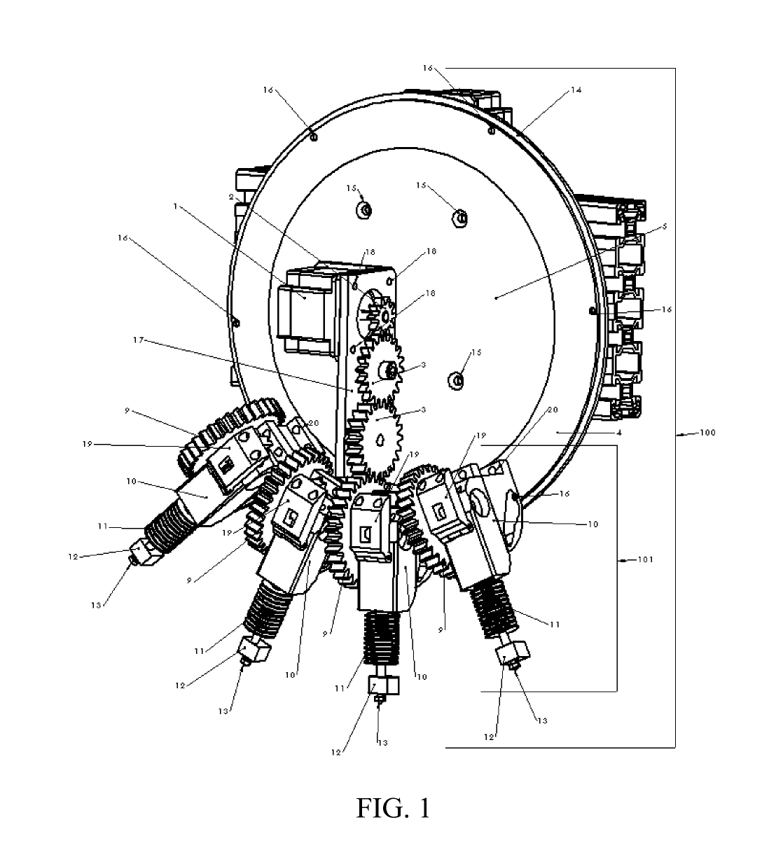

Accordingly, one embodiment of the invention allows the use of a rotating motor for rotating print heads to be selectively engaged and a driving motor for driving multiple print heads. In view of FIG. 1 a system of a 3D printer extrusion assembly 100 comprises multiple printheads 101 as depicted. A primary feature of the system is that the multiple print heads 101 are all aligned on the x-axis, but the print heads do not each require their own individual motors to extrude material as in a typical system. This alignment saves valuable x-axis space and uses off-the-shelf motors thus providing an efficient and economical system for 3D printing. In addition, this design allows for only one printhead at a time to be immediately adjacent to the printbed - which prevents the other nozzles, that are rotationally away from the printbed, from crashing into the material extruded by the operating printhead and potentially destroying the print.

FIG. 1 depicts a 3D printer extrusion assembly 100 comprising a driving motor 1, which is a dual pole stepper motor in preferred embodiments. The driving motor 1 is in a fixed position and attached to the gear train alignment block 17, which is attached to the front plate 5. Attached to the driving motor 1 is the drive motor pinion gear 2 that is further driving a gear chain 3. The drive motor pinion gear 2 translates movement of the drive motor 1 to drive the gear chain 3. The gear chain 3, as depicted in FIG. 1 comprises a configuration of gears such that the drive motor pinion gear 2 can drive several gears to mesh and translate power to the individual print head gear 9 that is engaged.

The driving gear chain 3 is located in the center of the assembly and it is fixed in its orientation on the gear train alignment block 17. The gear train alignment block 17 keeps the gear chain 3 aligned together on the same plane with the drive pinion gear 2 and the location of the print head gear 9 currently selected so that it can mesh with the various printhead gears 9 as depicted in FIG. 1.

When a print head 101 is moved to engage the print head gears 9 to the gear chain 3, it is possible that the gears will not be properly meshed, and that the gears may improperly contact and fail to engage, or worse, cause damage to the machine. Accordingly, in a preferred embodiment the printhead gear 9 and the last gear on the gear chain 3, as well as the various printhead gears 9, have additional curvature on the teeth of the gears like the gears in a Bendix drive system to prevent difficulty with meshing of the gears as the rotating ring 4 is revolved into position. This is to enable the gears to properly mesh together when different print heads are engaged to the drive train. Accordingly, by use of curved gears, such as the Bendix drive system style gears, the gears are able to seamlessly mesh together and prevent such contact.

Further embodiments employ a system where the gear train, once it comes into contact with the print head gear 9, “creeps” as it is pushed together to engage. This provides that slight movement of the gears ensures that the gears are not stationary as they are trying to mesh, but able to slowly move until appropriate engagement is met.

Finally, other embodiments use a mechanism to engage and disengage the gear chain 3 by moving the gear chain slightly away from the gears and then moving it back into place to engage once the print head 101 is in position. Further embodiments may also use a spring release system that would allow a spring to move the gear chain 3 or the print head 101 out of direct engagement with the gears, until it is ready to be engaged back into place. Finally, it may be advantageous to use a bump in the rotation path, such that the print head 101 is slightly pushed away from the gear chain 3, almost immediately adjacent to its engagement position, to allow for the gears to separate and then mesh together properly. Of course, in preferred embodiments, it may be advantageous to utilize one or more of these features, or combinations thereof, to ensure seamless operation and movement of the print heads. In essence, the concept is to allow for controlled separation of the gear systems to ensure that they can properly engage, disengage, and then re-engage and new print head gear 9 for use in the system. This controlled separation allows for exchange of print heads 101 without damage to the system.

A selection motor 21 turns the ring 4 so as to engage different print heads 101. In preferred embodiments, the selection motor 21 is a stepper motor. Once engaged, the print head gear 9 is driven by the gear chain 3 while the front plate 5 and the back plate 6 do not rotate. The front plate 5 provides a point of attachment for the drive motor 1 and the gear chain 3; however it remains stationary and does not rotate. The back plate 6 attaches to the front plate and together they keep the rotation ring 4 in place on the plane. Situated between the front plate 5 and the rotating ring 4 is a front bearing ring 7 which is a thin sheet of nylon sandwiched between the front plate and the revolving ring. This serves to reduce the friction between the front plate 5 and the rotating ring 4 allowing for smooth and continuous rotation.

In other embodiments, the rotating ring 4 may be a shape other than a ring. Accordingly, the rotating ring 4 may be described as a rotating plate and be a non-circular shape in certain embodiments. The feature that is being supported is that the print heads 101 are engaged and then moved out of engagement and replaced by another print head 101 that is located on a rotatable feature. Software could allow for various shaped systems to allow for use of various shaped systems. However, the constant feature, even in such circumstances, is that the different print heads 101 are rotated into position and driven by a single motor.

Indeed, the rotation of the print heads 101 may be completed without a rotation motor 21. For example, the rotation could be done by hand. Furthermore, systems could utilize solenoids or actuators to rotate or move the rotating plate into position along the axis. However, preferred embodiments use a ring shape to efficiently move print heads 101 into and out of position to be used in the printer system as described herein.

A back bearing ring 8 is a second nylon bearing sandwiched between the back plate 6 and the rotating ring 4, and serves to reduce friction between these two moving parts. As with any bearings, the front bearing ring 7 and back bearing ring 8 may wear and as with all other parts is replaceable to ensure that the system performs optimally. Furthermore, these bearings may be any other suitable material as is known to one of ordinary skill in the art, not simply the nylon bearing utilized herein.

After rotation and once a print head is engaged, the drive motor 1 thus drives the gear chain 3 and the print gear head 9 and thus the print head is engaged to print material from the head. The printhead gear 9 is secured to the printhead block 10, which is fastened with a knurled bolt and when meshed with the gear chain 3 can drive filament both forwards and backwards (depending on the rotating of the gear chain 3) through the heat sink 11, the heater block 12, and the nozzle 13.

The rotating ring 4 contains an internal gear 14 fastened to it with holes 16 along the ring. This internal gear 14 allows a second motor to rotate the ring forwards or backwards to change printhead blocks 10 during the printing process.

The printhead block 10 consists of the nozzle 13, the heater block 12, the printhead gear 9, the heat sink 11, and the filament alignment flap 19. These components can be such components are readily available off the shelf and are known to one of ordinary skill in the art. The print head gear 9, when engaged with the gear chain 3, is driven by the gear chain 3, using the driving motor 1. The printhead gear 9 then pushes the filament through the heat sink 11, the heater block 12, and the nozzle 13. The printhead blocks 10 are fastened to the rotating ring 4 with holes 20 which go through the rotating ring 4.

Further attached to the printhead block 10 is a filament alignment flap 19, which serves to keep the filament in position and ready for printing. This alignment flap 19 is simply used to secure the filament in position on the printhead.

Further depicted in FIG. 1 is a gear train alignment block 17, which is utilized to keep the gear chain 3, aligned on the same plane so that it can mesh with each of the various printhead gears 9 to drive filament through a nozzle 13. The gear train alignment block 17 is secured to the front plate 5 and so it does not revolve, but remains stationary, fastened to the font plate 5.

Further depicted in FIG. 1 are several holes, at feature 15, 16, 18 and 20. The holes 15 allow the front and back plates to be fastened together and then to a gantry system. The holes 16 allow fastening of the rotating ring 4 to the internal gear 14. The holes 18 allow the gear train alignment block 17 to be secured to the drive motor 1. Finally, the holes 20 allow the various printheads 101 to be fastened to the rotating ring 4. In each case, the holes provide openings for different fastening devices such as threaded fastens such as screws or bolts, or the like. Similarly, more permanent fasteners, such as rivets or welds may also be utilized where appropriate.

The drive chain 3 may be replaced by other systems known to one of skill in the art. For example, any number of belt driven systems, or direct drive systems, or other power transmission methods are suitable for use. For example, the direct drive system could use an axle like component to attach directly to each of the print heads, wherein the print head gear 9 would be replaced to a suitable direct drive component. Similarly, using a belt or chain system, such components could be tailored to work appropriately. However, the ability to rotate the rotating ring 4 remains, to allow for selection of the appropriate printer component as necessary for the system to function.

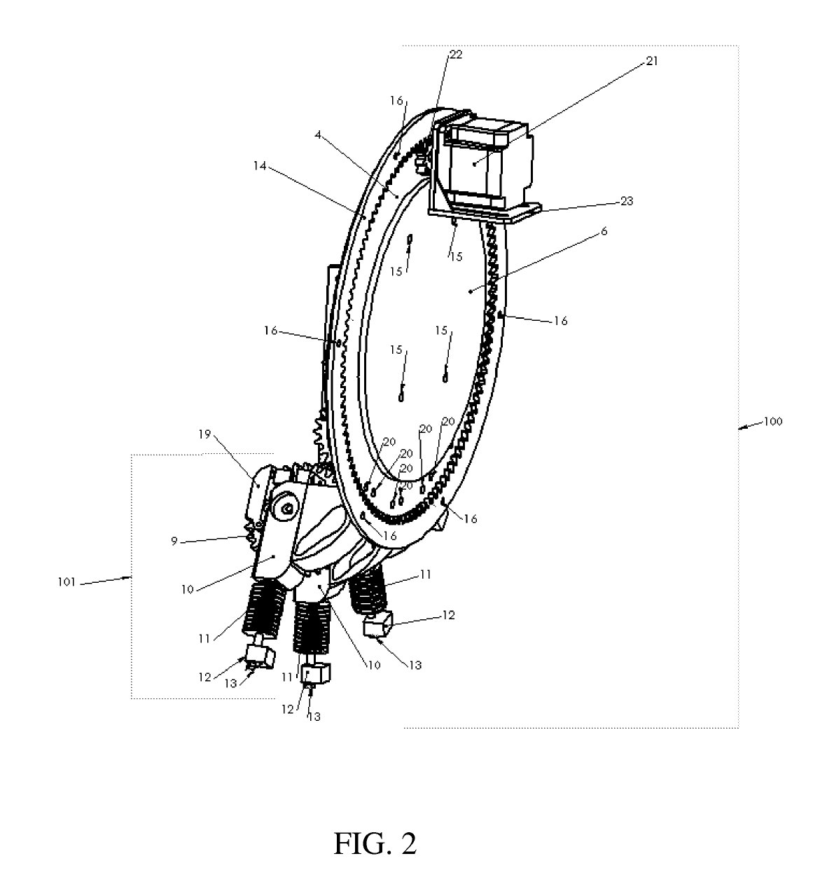

In view of FIG. 2 the internal gear 14 is fastened to the outer ring 4 which is revolved around the back plate 6 by a when the internal gear is driven forward or backward by the selection motor pinion gear 22 which is turned by the selection motor 21. This section motor 21 can be attached to the gantry system of the 3D printer with the selection motor bracket 23.

If a new print head 101 needs to be utilized, then the selection motor 21 is engaged to rotate the rotating ring 4, which rotates and engages with a different print head 101. This process is repeated as necessary to ensure that the appropriate print head is engaged to perform the 3D printing.

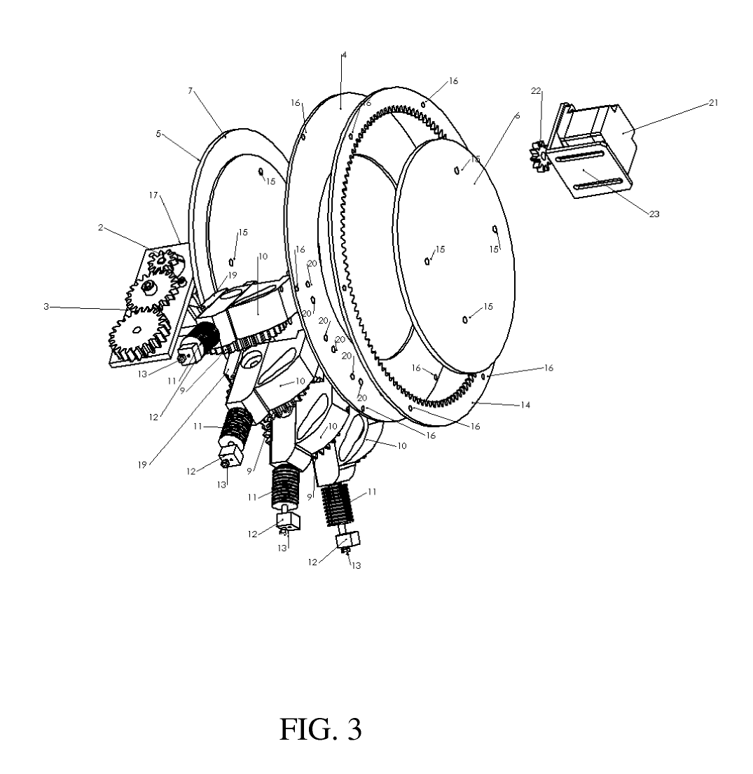

In view of FIG. 3. The exploded view of the assembly illustrates the connection between the back plate 6 which is fastened to the front plate 5. The rotating ring 4 is sandwiched between the front plate 5 and the back plate 6. Moreover, between the rotating ring 4 and the front plate is a front bearing ring 7 which serves to reduce the friction between the front plate 5 and the rotating ring 4, thus reducing friction and allowing for smooth rotation. The back bearing ring 8 serves a similar purpose, reducing friction between the rotating ring 4 and the back plate 6. The internal gear 4 is shown to be driven by the section motor pinion 22, which is attached to the selection motor 21. The selection motor can be fastened down with the selection motor bracket 23.

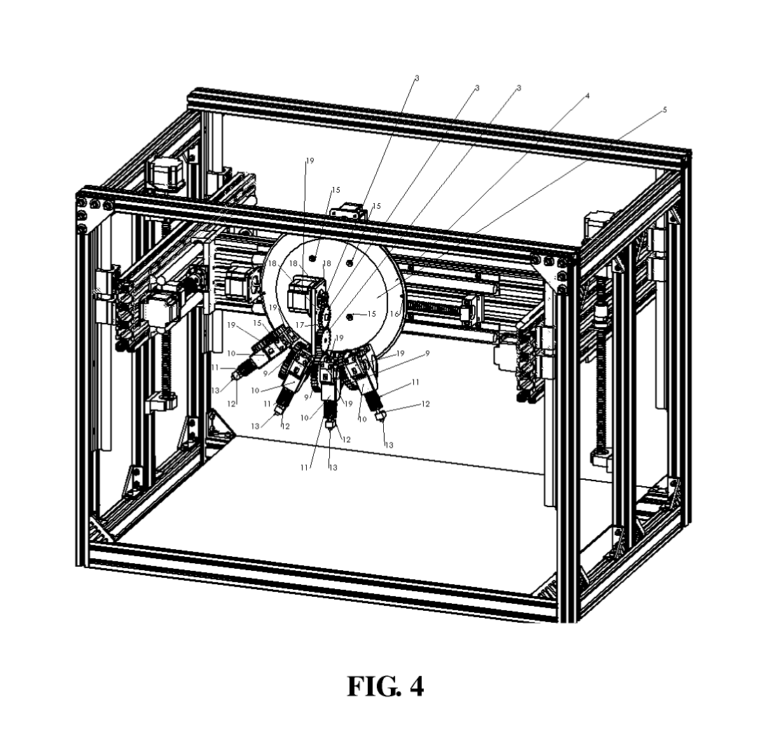

In view of FIG. 4. The entire two-motor multi-head 3D printer extrusion system is shown mounted in a gantry. This illustrates how, by design, the engaged print head 10 being driven by the gear train 3 has a nozzle 13 which is lower than the other nozzles 13 not currently in alignment with the gear train 3 to be driven. This is particularly relevant to printing in 3D as it allows material to be applied in layers without the additional print heads being in the way or potentially contacting the printed material.

Accordingly, in a typical scenario, when the 3D printer is in use, a CAD file or 3D scan is converted into g-code, which instructs the positioning of the print head assembly 100 in the Cartesian gantry as well as the selection of the print head 101 to be used. Following this g-code instructions the 3D print head 101 will lay down a thin layer of material in the appropriate locations on the printbed. If the type of material should be different in various locations on the printbed, the rotating ring 4, with the attached printheads 101, will revolve selecting the appropriate printhead with a different material. In this manner, a 3D object can be printed layer by layer and allow for simple and easy changes of the material being printed by changing the printhead being utilized. The benefit of such novel design, is that multiple print heads can be used in the same print, without increasing the number of motors required, overly limiting the space on the x axis, or having other printhead crashing into material extruded by another printhead—as the printheads are never on the same plane.

In particular embodiments, the print heads 101, or another printing component such as a laser 25 or spindle 24 are selectively attached to the rotating ring 4, to allow for selective removal from the system. This is important as parts may need to be replaced from time to time or other cleaning or services to the system. Accordingly, use of simple selective attachment mechanisms as known to one of skill in the art, allows for these components to be selectively fixed into place until their removal is needed or warranted. For example, such selective attachment mechanisms include threaded fasteners, snap systems, latches, locking mechanisms, or the like, which are known to one of ordinary skill.

In alternative embodiments, the number of print heads is not limited. While it is depicted that four print heads are utilized, the number of print heads is only limited by the space on the rotating ring within the assembly, and thus the system may comprise at a minimum of two print heads, and may contain more than the four print heads that are depicted in FIGS. 1-4.

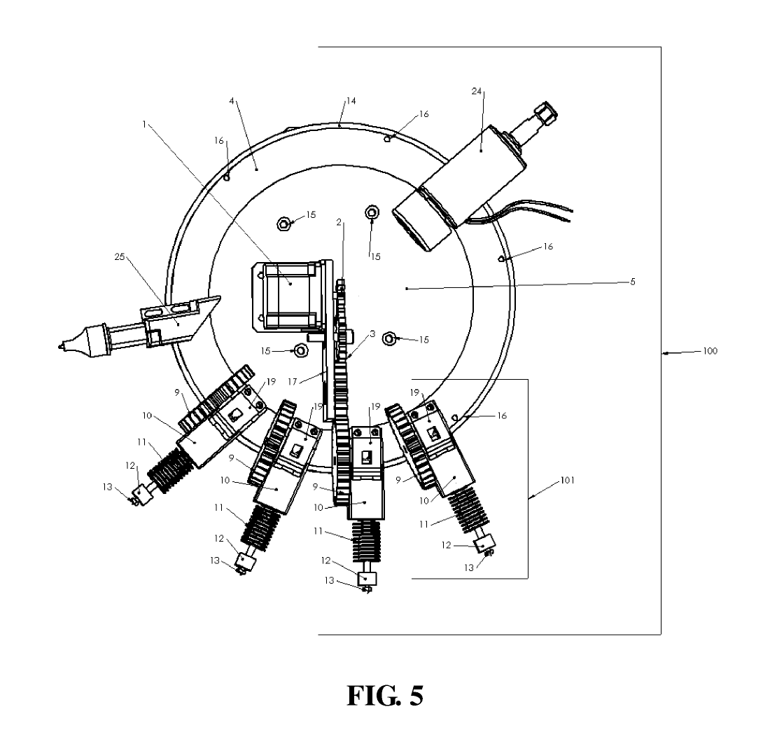

In view of FIG. 5, further components may be utilized on the rotating ring 4 that allow for not only addition of material through a print head 101, but also removal of materials in certain circumstances. Accordingly, a spindle 24 may be engaged in place of a print head 101, and used to remove, scar, or otherwise modify material that is already printed. This may be suitable for numerous aspects where in order to build certain designs, it is necessary to have underlying material that needs to be later replaced. By removing such material at the earliest point in the printing process, it may be easier to remove such material than by removing the material at a later point.

Further features, such as a laser 25 may also be used to remove, scar, or otherwise modify material that is already printed.

Accordingly, in systems that utilize several different extrusion materials, a single 3D printing system as described by the embodiments herein may be utilized to seamlessly print with several different materials, or even to remove materials from the printed material, without having to transfer the material to a new machine, or to completely replace a printing head or removal device in an existing machine. Accordingly, significant cost and time savings can be realized by the ability to use a single machine to print in several different materials. Furthermore, because each of the print heads utilize only a single mother, service or repair of such motors is easy to access, and issues with such motors are easy to diagnose.

The 3D printing system can be utilized in several printing mechanisms including a Delta style printer. A Delta style printer uses a very different approach to moving the nozzle of a 3D printer in a controlled fashion. As opposed to the familiar Cartesian gantry system, a delta style 3D print typically uses three runners on long vertical rails, each with an arm connected to the print head. These arms move up and down independently to the print-nozzle, while keeping it parallel to the base at all times. It is envisioned that our printhead system could be mounted and used in a delta style 3D printer in a different embodiment. The differences between Delta and Cartesian printers is easily differentiated, but for example the follow reference is helpful in some circumstances to identify differences. http//printspace3d.com/cartesian-vs-delta-printers-work.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

What is claimed is:

1. A 3D printing system comprising: a rotating motor, a driving motor and a multi-head filament extruder system that controls at least two 3D printer printheads, wherein, the system further comprises:
a. a rotating ring, wherein the at least two printheads are fastened to said ring and wherein said printheads can be individually selected and switched out during a print by rotating the ring with the rotating motor; and
b. wherein the driving motor engages with a print head when the print head is aligned and positioned to engage such motor.

2. The 3D printing system of claim 1 wherein the at least two printheads each utilize a different additive or subtractive tool or tooling.

3. The 3D printing system of claim 1 further comprising a spindle attached on said rotating ring.

4. The 3D printing system of claim 1 further comprising a laser attached on said rotating ring.

5. The 3D printing system of claim 1 wherein the driving motor transmitting power to a print head transmits such power through a group consisting of a gear drive system, belt systems, direct drive systems, or other power transmission methods, and combinations thereof, to drive the print head.

6. The 3D printing system of claim 1 wherein the rotating motor is replaced with another mechanical device capable or rotating the rotating ring.

7. The 3D printing system of claim 5 wherein the gear drive system is a Bendix drive system gears comprising curved gears to seamlessly engage the gears.

8. The 3D printing system of claim 1 wherein the printheads are selectively attached to the 3D system, thereby allowing for selective removal.

9. The 3D printing system of claim 1 wherein low friction material is set in between the front central disk and the rotating portion as well as between the rotating portion of the system and the back central disk.

10. The 3D printing system of claim 1 comprising at least three or more print heads.

11. A 3D printing system comprising a rotating plate, at least one fixed plate, a rotating device, and a driving motor that is selectively attached to the fixed plate, wherein attached to the rotating plate are at least two printing components, wherein the printing components are selectively attached to the rotating ring, and wherein the rotating device rotates the rotating ring wherein the printing components are selectively engaged with the driving motor.

12. The 3D printing system of claim 11 wherein the system further comprises a gear drive system attached to the driving motor and a gear mechanism on the printing components for selectively engaging the components to the driving motor, wherein the gear drive system is a Bendix drive system gears comprising curved gears to seamlessly engage the gears.

13. The 3D printing system of claim 11 wherein the 3D printing system further comprises a controlled separation mechanism to separate the driving motor gear mechanism from the gear mechanism on the printing components so as to disengage and then re-engage the gears as the printing components are rotated.

14. The 3D printing system of claim 11 further comprising a gear secured to the rotating plate, wherein said gear allows for selective rotation of the rotating plate.

15. The 3D printing system of claim 11 wherein the printing components are selectively attached to the 3D system, thereby allowing for selective removal.

16. The 3D printing system of claim 11 comprising at least three or more printing components.

17. A 3D printing system comprising a rotating plate, at least one fixed plate, a rotating device, and a driving motor that is selectively attached to the fixed plate, wherein attached to the rotating plate are at least two printing components, wherein the printing components are selectively secured to the rotating ring, and wherein the rotating device rotates the rotating plate wherein the printing components are selectively engaged with the driving motor, and wherein the system further comprises a gear mechanism attached to the driving motor and a gear mechanism on the printing components for selectively engaging the components to the driving motor, wherein the 3D printing system further comprises a controlled separation mechanism to separate the driving motor gear mechanism from the gear mechanism on the printing components so as to disengage and then re-engage the gears as the printing components are rotated.

18. The 3D printing system of claim 17 wherein the rotating plate is a non-circular shape.

19. The 3D printing system of claim 17 comprising at least three printing components.

20. The 3D printing system of claim 17 comprising at least four printing components.
